(19) United States
(12) Patent Application Publication
(10) Pub. No.: US 2026/0058798 A1
(43) Pub. Date: Feb. 26, 2026

(54) DATA MATCHING METHOD

(71) Applicant: CHINA UNIONPAY CO., LTD., Shanghai (CN)

(72) Inventors: Shuo HE, Shanghai (CN); Hongbao LIU, Shanghai (CN); Jianbin ZHENG, Shanghai (CN); Pengfei GAO, Shanghai (CN); Liang LI, Shanghai (CN)

(21) Appl. No.: 19/102,188

(22) PCT Filed: Dec. 7, 2022
(86) PCT No.: PCT/CN2022/137361

§ 371 Date: Feb. 7, 2025

(30) Foreign Application Priority Data
Aug. 9, 2022 (CN) 202210952494.8

(51) Int. Cl. H04L 9/08; H04L 9/00

(52) U.S. Cl. CPC H04L 9/0825; H04L 9/008; H04L 9/0861

(57) ABSTRACT

Disclosed in the present disclosure are a data matching method. In the present disclosure, a first vector corresponding to first data and a second vector corresponding to second data are respectively obtained; a first encrypted vector obtained by means of encrypting the first vector and a second encrypted vector obtained by means of encrypting the second vector are acquired; a first encrypted distance is calculated on the basis of the first encrypted vector and the second encrypted vector; a target distance between the first vector and the second vector is determined on the basis of the first encrypted distance and a first target private key; and on the basis of the target distance and a first preset distance threshold value, it is determined whether the first data matches the second data.

### CROSS-REFERENCE TO RELATED APPLICATIONS

The present disclosure is a national phase entry under 35 U.S.C § 371 of International Application No. PCT/CN2022/137361, filed on Dec. 7, 2022, which claims priority of a Chinese patent application submitted to the China National Intellectual Property Administration on Aug. 9, 2022, with the application number 202210952494.8 and the application title “A data matching method, apparatus and system, and device and medium”. The entire disclosure of the above applications is incorporated herein by reference.

### TECHNICAL FIELD

The present disclosure relates to the field of data processing technology, and in particular, to a data matching method, apparatus, system, device and medium.

### BACKGROUND

Current privacy computing technology is mainly used in secure intersection and federated learning. The so-called secure intersection refers to identifying the intersection of data from both parties, for example, identifying the shared users of organization A and organization B. The secure intersection is also the first step in vertical federated learning. That is to say, first the key information such as mobile phone number, ID number and business license number, etc, are securely exchanged before proceeding to the next step of joint modeling and other steps.

In related art, in order to identify the intersection of data from both parties or achieve matching of data from both parties, common secure intersection algorithms include secure intersection algorithms based on RSA encryption algorithms. However, the current safe intersection algorithm can only match successfully when the data of both parties are exactly the same, that is, when the data types of both parties and the number of characters contained in the data are exactly the same. However, in actual business, there are often many application scenarios in which data are to be matched when the data are not exactly the same. Therefore, the secure intersection algorithm in the related art greatly limits its application scenarios and affects the business scope of matching.

### SUMMARY

In the first aspect, the present disclosure provides a data matching method, which is applied to the first device. The method includes:
inputting first data to be matched into a pre-trained vector conversion model, and obtaining a first vector corresponding to the first data;
using a first target public key generated by the first device to perform semi-homomorphic encryption on the first vector to generate a first encrypted vector, and sending the first target public key and the first encrypted vector to a second device;
obtaining a first encrypted distance sent by the second device, wherein the first encrypted distance is calculated based on the first encrypted vector and a second encrypted vector, the second encrypted vector is obtained by performing the semi-homomorphic encryption on a second vector by using the first target public key, and the second vector is obtained by inputting second data into a pre-trained vector conversion model in the second device;
determining a target distance between the first vector and the second vector based on the first encrypted distance and a first target private key corresponding to the first target public key; and
determining whether the first data matches the second data based on the target distance and a first preset distance threshold.

In the second aspect, the present disclosure provides a data matching method, which is applied to the second device. The method includes:
inputting second data to be matched into a pre-trained vector conversion model, and obtaining a second vector corresponding to the second data;
receiving a first target public key and a first encrypted vector sent by the first device, and using the first target public key to perform semi-homomorphic encryption on the second vector to generate a second encrypted vector; wherein the first encrypted vector is obtained by performing the semi-homomorphic encryption on a first vector by using the first target public key, and the first vector is obtained by inputting first data into a pre-trained vector conversion model in the first device; and
calculating a first encrypted distance based on the first encrypted vector and the second encrypted vector, and sending the first encrypted distance to the first device, to cause the first device to determine a target distance between the first vector and the second vector based on the first encrypted distance and a first target private key corresponding to the first target public key, and to cause the first device to determine whether the first data matches the second data based on the target distance and a first preset distance threshold.

In the third aspect, the present disclosure provides a data matching device, applied to the first device, including:
a first obtaining module, configured to input first data to be matched into a pre-trained vector conversion model, and obtain a first vector corresponding to the first data;
a first processing module, configured to use a first target public key generated by the first device to perform semi-homomorphic encryption on the first vector to generate a first encrypted vector, and send the first target public key and the first encrypted vector to a second device;
the first obtaining module is further configured to obtain a first encrypted distance sent by the second device, wherein the first encrypted distance is calculated based on the first encrypted vector and a second encrypted vector, the second encrypted vector is obtained by performing the semi-homomorphic encryption on a second vector by using the first target public key, and the second vector is obtained by inputting second data into a pre-trained vector conversion model in the second device;
a first determining module, configured to determine a target distance between the first vector and the second vector based on the first encrypted distance and a first target private key corresponding to the first target public key, and determine whether the first data matches the second data based on the target distance and a first preset distance threshold.

In the fourth aspect, the present disclosure provides a data matching device, applied to a second device, the data matching device includes:
a second obtaining module, configured to input second data to be matched into a pre-trained vector conversion model, and obtain a second vector corresponding to the second data;
a second processing module, configured to receive a first target public key and a first encrypted vector sent by the first device, and use the first target public key to perform semi-homomorphic encryption on the second vector to generate a second encrypted vector; wherein the first encrypted vector is obtained by performing the semi-homomorphic encryption on a first vector by using the first target public key, and the first vector is obtained by inputting first data into a pre-trained vector conversion model in the first device; and
a second determining module, configured to calculate a first encrypted distance based on the first encrypted vector and the second encrypted vector, and send the first encrypted distance to the first device to cause the first device to determine a target distance between the first vector and the second vector based on the first encrypted distance and a first target private key corresponding to the first target public key and to cause the first device to determine whether the first data matches the second data based on the target distance and a first preset distance threshold.

In the fifth aspect, the present disclosure provides a data matching system, including:
a first device, configured to input first data to be matched into a pre-trained vector conversion model, and obtain a first vector corresponding to the first data; and use a first target public key generated by the first device to perform semi-homomorphic encryption on the first vector to generate a first encrypted vector, and send the first target public key and the first encrypted vector to a second device; and
the second device, configured to input second data to be matched into a pre-trained vector conversion model in the second device, and obtain a second vector corresponding to the second data; and receive the first target public key and the first encrypted vector sent by the first device, use the first target public key to perform the semi-homomorphic encryption on the second vector to generate a second encrypted vector; and calculate a first encrypted distance based on the first encrypted vector and the second encrypted vector, and send the first encrypted distance to the first device;
the first device is further configured to determine a target distance between the first vector and the second vector based on the first encrypted distance and a first target private key corresponding to the first target public key, and determine whether the first data matches the second data based on the target distance and a first preset distance threshold.

In the sixth aspect, the present disclosure provides an electronic device, comprising a processor and a memory, wherein the memory is configured to store program instructions, and the processor is configured to implement the data matching method according to any one of above embodiments when executing the program instructions stored in the memory.

In the fifth aspect, the present disclosure provides a computer-readable storage medium storing a computer program, wherein when the computer program is executed by a processor, the data matching method according to any one of above embodiments is implemented.

### BRIEF DESCRIPTION OF FIGURES

In order to more clearly illustrate the technical solutions in the embodiments of the present disclosure, the following will briefly introduce the drawings needed to describe the embodiments. Obviously, the drawings in the following description are only some embodiments of the present disclosure. Those of ordinary skill in the art can also obtain other drawings based on these drawings without exerting any creative effort.

FIG. 1 is a schematic diagram of a data matching process provided by an embodiment of the present disclosure;

FIG. 2 is a schematic diagram of the second data matching process provided by an embodiment of the present disclosure;

FIG. 3 is a schematic diagram of the third data matching process provided by an embodiment of the present disclosure;

FIG. 4 is a schematic diagram of a structure of a data matching device provided by an embodiment of the present disclosure;

FIG. 5 is a schematic diagram of a structure of another data matching device provided by an embodiment of the present disclosure;

FIG. 6 is a schematic diagram of a structure of a data matching system provided by an embodiments of the present disclosure;

FIG. 7 is a schematic structural diagram of an electronic device provided by an embodiment of the present disclosure.

### DETAILED DESCRIPTION

In order to ensure that matching can be performed even when the data of both parties are not exactly the same, and to broaden the business scope of data matching, embodiments of the present disclosure provide a data matching method, apparatus, system, device, and medium.

In order to make the purpose and implementation of the present disclosure clearer, the exemplary embodiments of the present disclosure will be clearly and completely described below in conjunction with the accompanying drawings in the exemplary embodiments of the present disclosure. Obviously, the described exemplary embodiments are only some of the embodiments of this disclosure, not all of them.

It should be noted that the brief description of terms in this disclosure is only to facilitate understanding of the embodiments described below, and is not intended to limit the embodiments of this disclosure. Unless otherwise stated, these terms should be understood according to their ordinary and usual meaning.

The terms “first”, “second”, “third”, etc. in the description and claims of this disclosure and the above-mentioned drawings are configured to distinguish similar or similar objects or entities, and do not necessarily mean to limit specific sequential or sequential order unless otherwise noted. It is to be understood that the terms so used are interchangeable under appropriate circumstances.

The terms “include” and “have” and any variations thereof are intended to cover but not exclusively include, for example, a product or device that contains a list of components need not be limited to all components expressly listed, but may include any components not expressly listed separately or inherent to these products or equipment.

The term “module” means any known or later developed hardware, software, firmware, artificial intelligence, fuzzy logic or combination of hardware or/and software code capable of performing the functions associated with that element.

Finally, it should be noted that the above embodiments are only configured to illustrate the technical solution of the present disclosure, but not to limit it. Although the present disclosure has been described in detail with reference to the foregoing embodiments, those of ordinary skill in the art should understand that: The technical solutions described in the foregoing embodiments can still be modified, or some or all of the technical features can be equivalently replaced, and these modifications or substitutions do not deviate the essence of the corresponding technical solutions from the scope technical solutions of the embodiments of the present disclosure.

### Embodiment 1

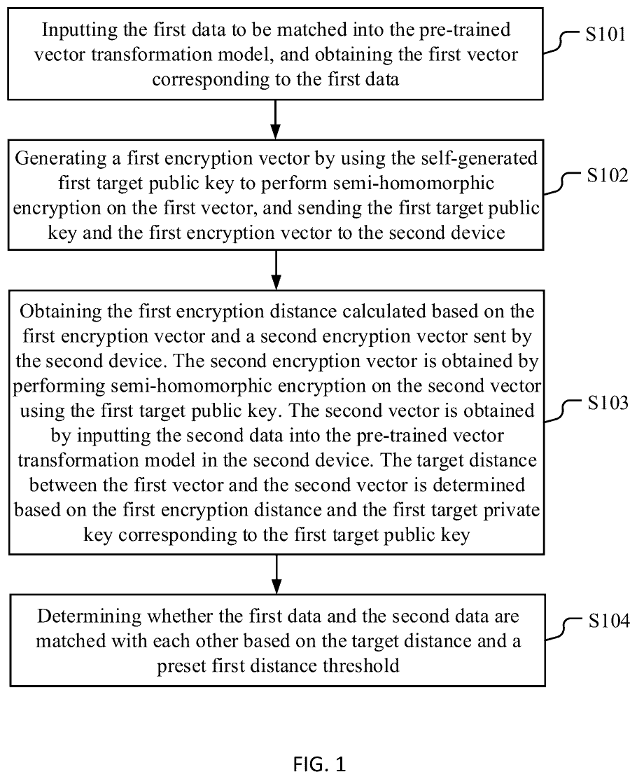

FIG. 1 is a schematic diagram of the first data matching process provided by an embodiment of the present disclosure. The process includes the following steps.

S101: inputting the first data to be matched into the pre-trained vector conversion model, and obtaining the first vector corresponding to the first data.

The data matching method provided by the embodiment of the present disclosure is applied to an electronic device (for convenience of description, referred to as the first device). The first device may be a smart terminal, a PC, a server, or other devices.

In order to ensure that fuzzy matching can be achieved even when the data of both parties are not exactly the same, in the embodiment of the present disclosure, a pre-trained vector conversion model is deployed in the first device. The pre-trained vector conversion model is configured to obtain vectors corresponding to the data to be matched, and for different data, the dimensions of the vectors output by the pre-trained vector conversion model can be the same.

In a possible implementation, in order to obtain the first vector (for the convenience of description, the vector corresponding to the first data is called the first vector) corresponding to the first data to be matched (for the convenience of description, the data to be matched stored in the first apparatus is called the first data), the first data can be input into the pre-trained vector conversion model, and the pre-trained vector conversion model can output the first vector corresponding to the first data. Optionally, each component in the first vector can be a number, that is, the first data can be quantified through the pre-trained vector conversion model. For example, taking the first data as “Qing canteen, Dongxin District, Sea City”, the first data “Qing canteen, Dongxin District, Sea City” can be input into the pre-trained word vector model. The first vector corresponding to the first data “Qing canteen, Dongxin District, Sea City” may be output as (1.0, 2.0, 1.5, 2.0, 3.5).

S102: generating a first encrypted vector by using the self-generated first target public key to perform semi-homomorphic encryption on the first vector, and sending the first target public key and the first encrypted vector to the second device.

In a possible implementation, in order to improve security, the first device can generate a first target public-private key pair. The first target public-private key pair includes the first target public key and the first target private key (for convenience of description, the public key generated by the first device is called the first target public key, and the private key generated by the first device is called the first target private key). Optionally, the first target public-private key pair may be a semi-homomorphic encryption public-private key pair, that is, the first target public key may be a semi-homomorphic encryption public key, and the first target private key may be a semi-homomorphic encryption private key. The first device may perform semi-homomorphic encryption on the first vector according to the first target public key generated by itself to generate the first encrypted vector. The first target public-private key pair may be a symmetric public-private key pair or an asymmetric public-private key pair, and the target public-private key pair may be set according to requirements. The process of generating the first target public-private key pair is an existing technology and will not be described in detail here.

In a possible implementation, since the second data to be matched with the first data is obtained by the second device, in order to facilitate subsequent determination of a target distance between the first vector corresponding to the first data and the second vector corresponding to the second data, the first device can send the first target public key and the first encrypted vector to the second device, and the second device can perform semi-homomorphic encryption on the second vector corresponding to the second data based on the first target public key to generate a second encrypted vector.

S103: obtaining the first encrypted distance calculated based on the first encrypted vector and a second encrypted vector sent by the second device. The second encrypted vector is obtained by performing semi-homomorphic encryption on the second vector using the first target public key. The second vector is obtained by inputting the second data into the pre-trained vector conversion model in the second device. The target distance between the first vector and the second vector is determined based on the first encrypted distance and the first target private key corresponding to the first target public key.

In a possible implementation, in order to achieve fuzzy matching between the first data and the second data, a pre-trained vector conversion model is also deployed in the second device to obtain the second vector (for convenience of description, the vector corresponding to the second data is called the second vector) corresponding to the second data to be matched (for convenience of description, the data to be matched in the second device is called the second data). Optionally, the second data can be input into a pre-trained vector conversion model, and the pre-trained vector conversion model can output a second vector corresponding to the second data, and the second device can perform semi-homomorphic encryption on the second vector based on the received first target public key sent by the first device to obtain the second encrypted vector.

In order to determine the distance between the first vector and the second vector, in a possible implementation, for each first encrypted component in the first encrypted vector and each second encrypted component in the second encrypted vector, the second device may determine the first encrypted square component of the first encrypted component, a product of the first encrypted component and a corresponding second encrypted component, and the second encrypted square component of the corresponding second encrypted component through a semi-homomorphic encryption algorithm, and determine the encrypted sub-distance corresponding to the first encrypted component based on the first encrypted square component, the product and the second encrypted square component, and determine a first encrypted distance between the first encrypted vector and the second encrypted vector based on the encrypted sub-distance corresponding to each first encrypted component. To facilitate understanding, the process of determining the first encrypted distance between the first encrypted vector and the second encrypted vector provided by the embodiment of the present disclosure is explained below in the form of a formula.

For example, assume that the first vector corresponding to the first data U1 is (x₁, x₂, x₃ . . . xₘ), and the second vector corresponding to the second data U5 is (y₁, y₂, y₃ . . . , yₘ).

The first device generates a first target public-private key pair A (pka1, ska1), pka1 is the first target public key and ska1 is the first target private key, and performs semi-homomorphic encryption on the first vector based on the first target public key to generate a first encrypted vector. For example, for each first component in the first vector, the semi-homomorphic encryption can be performed on each first component in the first vector based on the first target public key to generate the first encrypted vector. For example, the first encrypted vector corresponding to the first vector (x₁, x₂, x₃ . . . , xₘ) is (Eₚₖₐ₁ (x₁), Eₚₖₐ₁ (x₂), Eₚₖₐ₁ (x₃) . . . , Eₚₖₐ₁ (xₘ)). The first encrypted vector includes m first encrypted components Eₚₖₐ₁ (x₁), i is any positive integer not greater than m. The first device may send the first encrypted vector and the first target public key to the second device.

After receiving the first target public key and the first encrypted vector sent by the first device, the second device can perform semi-homomorphic encryption on the second vector based on the first target public key to obtain the second encrypted vector. For example, for each second component in the second vector, semi-homomorphic encryption can be performed on each second component in the second vector based on the first target public key to generate a second encrypted vector. For example, the second encrypted vector corresponding to the second vector (y₁, y₂, y₃ . . . , yₘ) is (Eₚₖₐ₁ (y₁), Eₚₖₐ₁ (y₂), Eₚₖₐ₁ (y₃) . . . , Eₚₖₐ₁ (yₘ)). The second vector includes m second components y₁, and the second encrypted vector includes m second encrypted components Eₚₖₐ₁ (y₁), i is any positive integer not greater than m.

In a possible implementation, for each first encrypted component Eₚₖₐ₁ (x₁) in the first encrypted vector, the second device may determine the first encrypted square component of the first encrypted component: Eₚₖₐ₁ (xᵢ²). In addition, for each first encrypted component Eₚₖₐ₁ (x₁) in the first encrypted vector, the second device can also determine the product of the first encrypted component and the corresponding second encrypted component through a semi-homomorphic encryption algorithm. In addition, the second device may also determine the second encrypted square component of the corresponding second encrypted component: Eₚₖₐ₁ (y₁²).

In a possible implementation, the process of determining the product of the first encrypted component and the corresponding second encrypted component by using a semi-homomorphic encryption algorithm, can be as follows:
through the semi-homomorphic encryption algorithm, the encrypted exponential power is determined, the base of the exponential power can be the first encrypted component, and the exponent of the exponential power can be the corresponding second component. For example, the exponential power can be Eₚₖₐ₁(x₁)^{y}^{ᵢ}, which can be used for determining the product of the first encrypted component encrypted based on the semi-homomorphic encryption algorithm and the corresponding second component. Among them, how to determine the product (Eₚₖₐ₁(xᵢyᵢ)) of the first encrypted component and the corresponding second component based on the exponential power will be described in detail later, and will not be described again here.

In a possible implementation, for each first encrypted component, the encrypted sub-distance Eₚₖₐ₁(xᵢ²)−2Eₚₖₐ₁(x₁)^{y}^{ᵢ}+Eₚₖₐ₁(yᵢ²) corresponding to the first encrypted component can be determined based on the first encrypted square component Eₚₖₐ₁ (xᵢ²) corresponding to the first encrypted component, the product Eₚₖₐ₁(xᵢ)^{y}^{ᵢ} of the first encrypted component and the corresponding second encrypted component, and the second encrypted square component Eₚₖₐ₁(yᵢ²). Optionally, the sum of encrypted sub-distance corresponding to each first encrypted component can be determined as the first encrypted distance

$${\sum }_{i = 1}^{m} ( {E}_{pka 1} ( {x}_{i}^{2} ) - 2 {{E}_{pka 1} ( {x}_{i} )}^{{y}_{i}} + {E}_{pka 1} ( {y}_{i}^{2} ) )$$

between the first encrypted vector and the second encrypted vector.

In a possible implementation, after the second device obtains the first encrypted distance, it may send the first encrypted distance to the first device. After receiving the first encrypted distance, the first device can decrypt the first encrypted distance according to the first target private key in the first target private key pair generated by the first device, and determine the target distance between the first vector and the second vector.

For example, the first device can decrypt the first encrypted distance according to the first target private key and obtain

$${\sum }_{i = 1}^{m} ( {x}_{i}^{2} - 2 {x}_{i} {y}_{i} + {y}_{i}^{2} ) .$$

To facilitate understanding, the following explains the process of how the first device determines the product Eₚₖₐ₁(xᵢyᵢ) of the first encrypted component and the corresponding second encrypted component based on the exponential power Eₚₖₐ₁(xᵢ)^{y}^{ᵢ}.

In the semi-homomorphic encryption algorithm, the operation of Eₚₖₐ₁(xᵢ) can be regarded as the operation of the first exponential powerg^{E}^{ₚₖₐ₁}^{(x}^{ᵢ}⁾, that is, Eₚₖₐ₁(xᵢ)=g^{E}^{ₚₖₐ₁}^{(x}^{ᵢ}⁾, g can be any base number.

$$Since {g}^{x + y} = {g}^{x} * {g}^{y} , then {E}_{pka 1} ( {x}_{i} + {y}_{i} ) = {E}_{pka 1} ( {x}_{i} ) * {E}_{pka 1} ( {y}_{i} ) .$$

And since xᵢyᵢ is equal to the sum of the number yᵢ of xᵢ, therefore,

$${E}_{pka 1} ( {x}_{i} {y}_{i} ) = {E}_{pka 1} ( {x}_{i} + {x}_{i} + … + {x}_{i} , the sum of the number {y}_{i} of {x}_{i} ) = {g}^{{E}_{pka 1} ( {x}_{i} )} * {g}^{{E}_{pka 1} ( {x}_{i} )} * … … * {g}^{{E}_{p k a 1} ( {x}_{i} )} ( the product of the number {y}_{i} of {g}^{{E}_{p k a 1} ( {x}_{i} )} ) = {( {g}^{{E}_{p k a 1} ( {x}_{i} )} )}^{{y}_{i}} = {{E}_{p k a 1} ( {x}_{i} )}^{{y}_{i}} .$$

It can be seen from the above formula that through the semi-homomorphic encryption algorithm, the product Eₚₖₐ₁(xᵢyᵢ) of the first encrypted component and the corresponding second encrypted component can be determined based on the exponential power Eₚₖₐ₁(xᵢ)^{y}^{ᵢ}, and the first device can then obtain

$${\sum }_{i = 1}^{m} ( {x}_{i}^{2} - 2 {x}_{i} {y}_{i} + {y}_{i}^{2} )$$

after decrypting the first encrypted distance according to the first target private key. The first device can calculate the target distance between the first vector and the second vector based on the decrypted first encrypted distance and the Euclidean distance formula. For example, the target distance between the first vector and the second vector is

$$d = \sqrt{{\sum }_{i = 1}^{m} ( {x}_{i}^{2} - 2 {x}_{i} {y}_{i} + {y}_{i}^{2} )} ,$$

xᵢ is the i-th component in the first vector, yᵢ is the i-th component in the second vector, and m is the number of components contained in the first vector or the second vector, and the number of components contained in the first vector is the same as the number of components contained in the second component, that is, the length of the first vector is equal to the length of the second vector. The lengths of the first vector and the second vector may both be a preset length m, and m may be any positive integer.

In another possible implementation, the distance between the first vector and the second vector can also be determined based on the cosine distance formula or the Hamming distance formula, which will not be described again here.

In addition, the embodiment of the present disclosure also provides another way to determine the first encrypted distance. In a possible implementation, the first encrypted distance can also be obtained by using the following process:
for each first encrypted component Eₚₖₐ₁(xᵢ) in the first encrypted vector, each second component y₁ in the second vector, and each second encrypted component Eₚₖₐ₁(yᵢ) in the second encrypted vector, the second device can determine the product Eₚₖₐ₁(xᵢ)^{y}^{ᵢ} of the first encrypted component and the corresponding second encrypted component, and the second encrypted square component Eₚₖₐ₁(yᵢ²) of the corresponding second encrypted component through a semi-homomorphic encryption algorithm. The second device can determine the encrypted sub-distance b=Eₚₖₐ₁(−2E^{pka1}(xᵢ)^{y}^{ᵢ}+yᵢ²) corresponding to the first encrypted component based on the product Eₚₖₐ₁(xᵢ)^{y}^{ᵢ} and the second encrypted square component Eₚₖₐ₁(xᵢ)^{y}^{ᵢ}.

The process of determining the product of the first encrypted component and the corresponding second encrypted component through a semi-homomorphic encryption algorithm is the same as the process of above embodiment. For example, the encrypted exponential power can be determined through a semi-homomorphic encryption algorithm, the base of the exponential power is the first encrypted component, and the exponent of the exponential power is the corresponding second component. The exponential power is used for determining the product of the first component and the corresponding second component which are encrypted based on the semi-homomorphic encryption algorithm, which will not be described in detail here.

The second device may send the encrypted sub-distance b to the first device, and the first device may determine the first encrypted square component Eₚₖₐ₁(xᵢ²) of each first encrypted component Eₚₖₐ₁(xᵢ)) in the first encrypted vector, and update the encrypted sub-distance corresponding to the first encrypted component based on the first encrypted square component Eₚₖₐ₁(xᵢ²) and the encrypted sub-distance Eₚₖₐ₁(−2Eₚₖₐ₁(xᵢ)^{y}^{ᵢ}+yᵢ²). Optionally, the encrypted sub-distance is updated to:

$${E}_{pka 1} ( {x}_{i}^{2} ) - 2 {{E}_{pka 1} ( {x}_{i} )}^{{y}_{i}} + {E}_{pka 1} ( {y}_{i}^{2} ) .$$

The first device may determine an updated first encrypted distance between the first encrypted vector and the second encrypted vector based on the updated sub-distance corresponding to each first encrypted component. Optionally, the sum of the updated sub-distances corresponding to each first encrypted component can be determined as the updated first encrypted distance between the first encrypted vector and the second encrypted vector:

$$\begin{matrix}{\sum }_{i = 1}^{m} ( {E}_{pka 1} ( {x}_{i}^{2} ) - \\ 2 {{E}_{pka 1} ( {x}_{i} )}^{{y}_{i}} + {E}_{pka 1} ( {y}_{i}^{2} ) ) .\end{matrix}$$

Similar to the above embodiment, after determining the updated first encrypted distance, the first device may decrypt the updated first encrypted distance according to the first target private key in the first target private key pair generated by the first device to determine the target distance between the first vector and the second vector.

For example, the first device can decrypt the updated first encrypted distance according to the first target private key to obtain

$${\sum }_{i = 1}^{m} ( {x}_{i}^{2} - 2 {x}_{i} {y}_{i} + {y}_{i}^{2} ) ,$$

and can calculate the target distance between the first vector and the second vector based on the decrypted first encrypted distance and the Euclidean distance formula. For example, the target distance between the first vector and the second vector is

$$d = \sqrt{{\sum }_{i = 1}^{m} ( {x}_{i}^{2} - 2 {x}_{i} {y}_{i} + {y}_{i}^{2} )} ,$$

which will not be described again here.

S104: determining whether the first data and the second data are matched with each other based on the target distance and a first preset distance threshold.

In a possible implementation, in order to determine whether the first data and the second data are matched with each other, after determining the target distance between the first vector and the second vector, the target distance can be compared with a first preset distance threshold. It is determined whether the first data and the second data are matched with each other based on a comparison result. For example, it can be determined whether the target distance between the first vector and the second vector is less than the first preset distance threshold. If the target distance between the first vector and the second vector is less than the first preset distance threshold, it can be considered that the first data matches the second data. And if the target distance between the first vector and the second vector is not less than the first preset distance threshold, it can be determined that the first data do not match the second data. Optionally, the first preset distance threshold can be 1, or 1.5, etc. This disclosure does not specifically limit the first distance threshold, which can be flexibly set according to needs. The smaller the target distance between the first vector and the second vector is, the closer the first vector and the second vector match.

In order to determine whether the second data completely matches the first data, in a possible implementation, it can also be determined whether the target distance between the first vector and the second vector is equal to a second preset distance threshold. If the target distance is equal to the second preset distance threshold, the first data and the second data can be considered to be the same, that is, the first data and the second data completely match. Optionally, the second distance threshold may be smaller than the first distance threshold, and the second distance threshold may be 0.

In this embodiment of the present disclosure, the first data to be matched and the second data to be matched can be input into the pre-trained vector conversion model, and the first vector corresponding to the first data and the second vector corresponding to the second data can be obtained. The first encrypted vector is obtained by encrypting the first vector, and the second encrypted vector is obtained by encrypting the second vector. The first encrypted distance is calculated based on the first encrypted vector and the second encrypted vector. The target distance between the first vector and the second vector is determined based on the first encrypted distance and the first target private key. It is determined whether the first data matches the second data based on the target distance and the first preset distance threshold, that is, when the first data is not exactly the same as the second data, fuzzy matching between the first data and the second data can also be achieved, broadening the usage scenarios, and the first target public key and the first target private key are introduced to semi-homomorphic encryption and decryption during the fuzzy matching process, thereby realizing safe intersection and ensuring the security of the matching process. During the entire matching process, neither the first data nor the second data leaves the corresponding first device and second device in the form of original data, which ensures the security of the first data and the second data, and enables fuzzy matching of the original data without leaving the database, further ensuring the security of the matching process.

### Example 2

In order to determine the first vector corresponding to the first data, based on the above embodiment, in the embodiment of the present disclosure, the inputting the first data to be matched into the pre-trained vector conversion model, and obtaining the first vector corresponding to the first data, includes:
determining the first target data type corresponding to the first data;
determining the first pre-trained target vector conversion model corresponding to the first data according to the corresponding relationship among the first target data type, the pre-stored data type and the pre-trained vector conversion model;
inputting the first data into the first pre-trained target vector conversion model to obtain the first vector corresponding to the first data.

In the embodiment of the present disclosure, the first data to be matched can be text data. For example, the first data can be name, gender, address, etc., or it can be numeric data. For example, the first data can be an ID card number, bank card number, admission ticket number, etc., can also be image data. For example, the first data can be an image used for face recognition, etc. Therefore, the pre-trained vector conversion models for obtaining the corresponding first vector may also be different for the first data of different data types.

Specifically, the corresponding relationship between the data type and the pre-trained vector conversion model can be stored in the first device. The first vector corresponding to the first data is obtained by the corresponding pre-trained vector conversion model according to the first target data type corresponding to the obtained first data to be matched. The corresponding pre-trained vector conversion model is also the first pre-trained target vector conversion model.

This disclosure does not specifically limit the first target data type corresponding to the first data. For example, the first target data type may be a text type, a numeric type, or an image type, etc. In addition, this disclosure does not specifically limit the vector conversion model corresponding to the data type, and can be flexibly set according to needs.

For example, in order to accurately determine the vector conversion model for converting the first data into the first vector, based on the above embodiments, in the embodiment of the present disclosure, if the first target data type is a text type, the first pre-trained target vector conversion model corresponding to the first target data type can be a word vector model or a sentence vector model; if the first target data type is a numeric type, then the first pre-trained target vector conversion model corresponding to the first target data type can be a One-Hot encoding model; if the first target data type is an image type, the first pre-trained target vector conversion mode corresponding to the first target data type is A target vector conversion model may be an image vector model.

Specifically, if the first data is text data, that is, the first target data type of the first data is a text type, the first pre-trained target vector conversion model can be determined based on the correspondence between the pre-stored data type and the pre-trained vector conversion model. The first target vector conversion model can be a word vector model or a sentence vector model. The first vector corresponding to the first data can be obtained based on the pre-trained word vector model or the pre-trained sentence vector model.

In a possible implementation, if the first data is numeric data, that is, the first target data type of the first data is a numeric type, the first pre-trained target vector conversion model corresponding to the first target data type can be determined according to the correspondence between the pre-stored data type and the pre-trained vector conversion model. The first target vector conversion model can be a pre-trained One-Hot encoding mode. The first vector corresponding to the first data can be obtained based on the pre-trained One-Hot encoding model.

In a possible implementation, if the first data is image data, that is, the first target data type of the first data is an image type, the first pre-trained target vector conversion model corresponding to the first target data type can be determined according to the corresponding correspondence between the pre-stored data type and the pre-trained vector conversion model. The first target vector conversion model can be a pre-trained image vector model (image vector embedding model). The first vector corresponding to the first data can be obtained based on the pre-trained image vector model.

To facilitate understanding, the dimension of the vector output by the pre-trained vector conversion model is 5 and the pre-trained vector conversion model is a word vector model as an example for explanation. If the first data is text data, and the first data is “Qing canteen, Dongxin District, Sea City”, then inputting “Qing canteen, Dongxin District, Sea City” into the pre-trained word vector model and outputting the first vector corresponding to “Qing canteen, Dongxin District, Sea City” as (1.0, 2.0, 1.5, 2.0, 3.5).

If the pre-trained vector conversion model is a One-Hot encoding model, the corresponding one-hot encoding can be set in advance for each number. For example, if the number contains 0-9, then among the numbers 0-9, the one-hot code corresponding to 0 is 0000000001, the one-hot code corresponding to 1 is 0000000010, the one-hot code corresponding to 2 is 0000000100, the one-hot code corresponding to 3 is 0000001000, the one-hot code corresponding to 4 is 0000010000, the one-hot code corresponding to 5 is 0000100000, the one-hot code corresponding to 6 is 0001000000, the one-hot code corresponding to 7 is 0010000000, the one-hot code corresponding to 8 is 0100000000, and the one-hot code corresponding to 9 is 1000000000. The numeric data is input into the One-Hot encoding model, and each first component in the first vector output by the One-Hot encoding model is the one-hot code of each corresponding number in the first data.

For example, if the first data is numeric data and the numeric data is “12345”, then inputting “12345” into the pre-trained word vector model, and outputting the first vector corresponding to the “12345” as (0000000010, 0000000100, 0000001000, 0000010000, 0000100000).

When training the vector conversion model, each data and the annotation vector corresponding to the data can be pre-annotated, each data and the corresponding annotation vector can, be input into the original vector conversion model and the parameters of the original vector conversion model are adjusted according to the prediction vector output by the original vector conversion model and the corresponding annotation vector, and when the convergence conditions are met, it is determined that the training of the vector conversion model is completed.

In the embodiment of the present disclosure, no matter whether both the first data and the second data are numeric data or text data, fuzzy matching can be achieved, further broadening the application scenarios.

### Example 3

In order to enable the second device to also determine whether the first data matches the second data, based on the above embodiments, in the embodiment of the present disclosure, after the target distance between the first vector and the second vector is determined, the method also includes:
sending the target distance to the second device, so that the second device determines whether the first data matches the second data based on the target distance and a first preset distance threshold.

In a possible implementation, in order to enable the second device to also determine whether the first data matches the second data, the first device may send the determined target distance between the first vector and the second vector to the second device. After receiving the target distance between the first vector and the second vector sent by the first device, the second device may determine whether the first data matches the second data based on the target distance and the first preset distance threshold. The process by which the second device determines whether the first data matches the second data may be the same as the process by which the first device determines whether the first data matches the second data in the above embodiment, which will not be described again here.

In a possible implementation, the first device determines whether the first data matches the second data, and after obtaining a matching result of whether the first data matches the second data, the matching result can be sent to the second device. Optionally, the second device can compare the matching result determined by the first device with the matching result determined by itself to further improve accuracy. In addition, in a possible implementation, the second device may not perform the process of determining whether the first data matches the second data and obtain the matching result, but directly use the matching result determined by the first device, thereby saving energy consumption.

To facilitate understanding, the data matching process provided by the present disclosure is explained below through a specific embodiment.

The first device may input the first data to be matched into a pre-trained vector conversion model deployed in the first device, and obtain a first vector corresponding to the first data. Similarly, the second device can input the second data to be matched into the pre-trained vector conversion model deployed in the second device to obtain the second vector corresponding to the second data. Assume that the first vector corresponding to the first data U1 is (x₁, x₂, x₃ . . . , xₘ), and the second vector corresponding to the second data U5 is (y₁, y₂, y₃ . . . , yₘ).

The first device generates a first target public-private key pair A (pka1, ska1), where pka1 is the first target public key and ska1 is the first target private key, and performs semi-homomorphic encryption on the first vector based on the first target public key to generate the first encrypted vector. The first encrypted vector corresponding to the first vector (x₁, x₂, x₃ . . . , xₘ) is (Eₚₖₐ₁(x₁), Eₚₖₐ₁(x₂), Eₚₖₐ₁(x₃) . . . , Eₚₖₐ₁(xₘ)), and sends the first encrypted vector and the first target public key to the second device.

After receiving the first target public key and the first encrypted vector sent by the first device, the second device performs semi-homomorphic encryption on the second vector based on the first target public key to obtain the second encrypted vector. Specifically, the second encrypted vector corresponding to the second vector (y₁, y₂, y₃ . . . , yₘ) is (Eₚₖₐ₁(y₁), Eₚₖₐ₁(y₂), Eₚₖₐ₁(y₃) . . . , Eₚₖₐ₁(yₘ)). The second device determines the first encrypted distance

$${\sum }_{i = 1}^{m} ( {E}_{pka 1} ( {x}_{i}^{2} - 2 {x}_{i} {y}_{i} + {y}_{{i}^{2}} ) )$$

based on the second encrypted vector and the received first encrypted vector and sends the first encrypted distance to the first device.

After receiving the first encrypted distance

$${\sum }_{i = 1}^{m} ( {E}_{pka 1} ( {x}_{i}^{2} - 2 {x}_{i} {y}_{i} + {y}_{i}^{2} ) ) ,$$

the first device decrypts the first encrypted distance according to the first target private key corresponding to the first target public key generated by itself to determine the target distance

$$d = \sqrt{{\sum }_{i = 1}^{m} ( {x}_{i}^{2} - 2 {x}_{i} {y}_{i} + {y}_{i}^{2} )}$$

of the first vector and the second vector. The first device can determine whether the first data matches the second data based on the target distance and the first preset distance threshold, and the first device can send the target distance between the first vector and the second vector to the second device. The second device can determine whether the first data matches the second data according to the target distance between the second vector and the first vector and the first preset distance threshold.

### Example 4

In order to enable the second device to also determine the target distance between the first vector and the second vector, based on the above embodiments, the method further includes:
receiving the third encrypted vector sent by the second device and the second target public key generated by the second device; the third encrypted vector is generated by the second device using the second target public key to perform semi-homomorphic encryption on the second vector;
performing semi-homomorphic encryption on the first vector based on the second target public key to generate a fourth encrypted vector;
calculating and obtaining a second encrypted distance based on the third encrypted vector and the fourth encrypted vector, and sending the second encrypted distance to the second device, so that the second device determines the target distance between the first vector and the second vector based on the second encrypted distance and the second target private key corresponding to the second target public key, and the second device determines whether the first data matches the second data based on the target distance and the first preset distance threshold.

In a possible implementation, in order to enable the second device to also determine the target distance between the first vector and the second vector without relying on the first device to send the determined target distance to the second device, further improving security, the second device can generate a second target public-private key pair. The second target public-private key pair includes the second target public key and the second target private key (for convenience of description, the public key generated by the second device is called the second target public key, the private key generated by the second device is called the second target private key). Optionally, the second target public-private key pair can be a semi-homomorphic encryption public-private key pair, that is, the second target public key can be a semi-homomorphic encryption public key, and the second target private key can be a semi-homomorphic encryption private key. The second device may perform semi-homomorphic encryption on the second vector according to the second target public key generated by itself to generate a third encrypted vector. The second target public-private key pair may be a symmetric public-private key pair or an asymmetric public-private key pair, and the target public-private key pair may be set according to requirements. The process of generating the second target public-private key pair is an existing technology and will not be described in detail here.

The second device may send the third encrypted vector and the second target public key generated by the second device to the first device. After receiving the third encrypted vector and the second target public key sent by the second device, the first device may perform semi-homomorphic encryption on the first vector based on the second target public key to generate a fourth encrypted vector.

The first device may also calculate and obtain the second encrypted distance based on the third encrypted vector and the fourth encrypted vector. The process of calculating the second encrypted distance is similar to the process of calculating the first encrypted distance. For example:
in a possible implementation, for each third encrypted component in the third encrypted vector, each fourth component in the fourth vector, and each fourth encrypted component in the fourth encrypted vector, the first device may determine the fourth encrypted square component of the fourth encrypted component, the product of the fourth encrypted component and the corresponding third encrypted component, and the third encrypted square component of the corresponding third encrypted component through the semi-homomorphic encryption algorithm, determine the encrypted sub-distance corresponding to the fourth encrypted component based on the fourth encrypted square component, the product and the third encrypted square component, and determine the second encrypted distance between the third encrypted vector and the fourth encrypted vector based on the encrypted sub-distance corresponding to each fourth encrypted component. To facilitate understanding, the process of determining the second encrypted distance provided by the embodiment of the present disclosure is explained below in the form of a formula.

For example, assume that the first vector corresponding to the first data U1 is (x₁, x₂, x₃ . . . , xₘ), and the second vector corresponding to the second data U2 is (y₁, y₂, y₃ . . . , yₘ).

The second device generates a second target public-private key pair B (pka2, ska2), where pka2 is the second target public key and ska2 is the second target private key, and performs semi-homomorphic encryption on the second vector based on the second target public key to generate a third encrypted vector. For example, the third encrypted vector corresponding to the second vector (y₁, y₂, y₃ . . . , yₘ) is (Eₚₖₐ₂(y₁), Eₚₖₐ₂(y₂), Eₚₖₐ₂(y₃), Eₚₖₐ₂(yₘ)), the third encrypted vector contains m third encrypted components Eₚₖₐ₂ (xᵢ), i is any positive integer not greater than m. The second device may send the third encrypted vector and the second target public key to the first device.

After receiving the second target public key and the third encrypted vector sent by the second device, the first device can perform semi-homomorphic encryption on the first vector based on the second target public key to obtain a fourth encrypted vector. For example, the fourth encrypted vector corresponding to the first vector (x₁, x₂, x₃ . . . , xₘ) is (Eₚₖₐ₂(x₁), Eₚₖₐ₂(x₂), Eₚₖₐ₂(x₃) . . . , Eₚₖₐ₂(xₘ)). The fourth encrypted vector contains m fourth encrypted components Eₚₖₐ₂(xᵢ), i is any positive integer not greater than m.

In a possible implementation, for each fourth encrypted component Eₚₖₐ₂ (xᵢ) in the fourth encrypted vector, the first device may determine a fourth encrypted square component of the fourth encrypted component: Eₚₖₐ₂ (xᵢ²). In addition, for each fourth encrypted component Eₚₖₐ₂ (xᵢ²) in the fourth encrypted vector, the first device may also determine the product of the fourth encrypted component and the corresponding third encrypted component, and the third encrypted square component Eₚₖₐ₂ (yᵢ²) of the corresponding third encrypted component.

The product of the fourth encrypted component and the corresponding third encrypted component can be determined by using the semi-homomorphic encryption algorithm provided in the above embodiment to determine the product of the first encrypted component and the corresponding second encrypted component. For example, the encrypted exponential power Eₚₖₐ₂(yᵢ)^{x}^{ᵢ} can be determined through the semi-homomorphic encryption algorithm. The base of the exponential power can be the third encrypted component, and the exponent of the exponential power can be the corresponding fourth component xᵢ. The exponential power is used for determining the product of the fourth component encrypted based on the semi-homomorphic encryption algorithm and the corresponding third encrypted component, which will not be described again here.

In a possible implementation, for each fourth encrypted component, the encrypted sub-distance Eₚₖₐ₂(xᵢ²)−2Eₚₖₐ₂(yᵢ)^{x}^{ᵢ}+Eₚₖₐ₂(yᵢ²) corresponding to the fourth encrypted component can be determined based on the fourth encrypted square component Eₚₖₐ₂(xᵢ²) corresponding to the fourth encrypted component, the product Eₚₖₐ₂(yᵢ)^{x}^{ᵢ} of the fourth encrypted component and the corresponding third encrypted component and the third encrypted square component Eₚₖₐ₂ (yᵢ)^{x}^{ᵢ}. Optionally, the sum of the encrypted sub-distances corresponding to each fourth encrypted component can be determined as the second encrypted distance between the third encrypted vector and the fourth encrypted vector:

$${\sum }_{i = 1}^{m} ( {E}_{pka 2} ( {x}_{i}^{2} ) - 2 {{E}_{p k a 2} ( {y}_{i} )}^{{x}_{i}} + {E}_{p k a 2} ( {y}_{i}^{2} ) ) .$$

In a possible implementation, after the first device obtains the second encrypted distance, it may send the second encrypted distance to the second device. After receiving the second encrypted distance, the second device may decrypt the second encrypted distance according to the second target private key in the second target private key pair generated by the second device itself to determine the target distance between the first vector and the second vector.

For example, the second device can decrypt the second encrypted distance according to the second target private key to obtain

$${\sum }_{i = 1}^{m} ( {x}_{i}^{2} - 2 {x}_{i} {y}_{i} + {y}_{i}^{2} ) ,$$

and can calculate the target distance between the first vector and the second vector based on the decrypted second encrypted distance and the Euclidean distance formula. For example, the target distance between the first vector and the second vector is

$$d = \sqrt{{\sum }_{i = 1}^{m} ( {x}_{i}^{2} - 2 {x}_{i} {y}_{i} + {y}_{i}^{2} )} ,$$

xᵢ is the i-th component in the first vector, yᵢ is the i-th component in the second vector components, m is the number of components contained in the first vector or the second vector, and the number of components contained in the first vector is the same as the number of components contained in the second component, that is, the length of the first vector is equal to the length of the second vector, the lengths of the first vector and the second vector can both be a preset length m, and m can be any positive integer.

In addition, the embodiment of the present disclosure also provides another way to determine the second encrypted distance. In a possible implementation, the second encrypted distance can also be obtained by using the following process.

For each fourth encrypted component Eₚₖₐ₂ (xᵢ) in the fourth encrypted vector and each third encrypted component Eₚₖₐ₂ (yᵢ) in the third encrypted vector, the first device may determine that the product Eₚₖₐ₂(y₁)^{x}^{ᵢ} of the fourth encrypted component and the corresponding fourth encrypted square component Eₚₖₐ₂(xᵢ²) of the fourth encrypted component. The first device may determine the encrypted sub-distance a=Eₚₖₐ₂ (xᵢ)²−2Eₚₖₐ₂(yᵢ)^{x}^{ᵢ}) corresponding to the fourth encrypted component based on the product Eₚₖₐ₂(yᵢ)^{x}^{ᵢ} and the fourth encrypted square component Eₚₖₐ₂(xᵢ²).

The first device may send the encrypted sub-distance a to the second device, and the second device may determine the third encrypted square component Eₚₖₐ₂(yᵢ²) of the third encrypted component for each third encrypted component Eₚₖₐ₂ (yᵢ) in the third encrypted vector. The square component Eₚₖₐ₂(yᵢ), and update the encrypted sub-distance corresponding to the fourth encrypted component based on the third encrypted square component Eₚₖₐ₂(yᵢ²) and the encrypted sub-distance Eₚₖₐ₂ ((xᵢ)²−2Eₚₖₐ₂(yᵢ)^{x}^{ᵢ}). Optionally, the encrypted sub-distance corresponding to the fourth encrypted component can be updated to:

$${E}_{pka 2} ( {x}_{i}^{2} ) - 2 {{E}_{pka 2} ( {y}_{i} )}^{{x}_{i}} + {E}_{pka 2} ( {y}_{i}^{2} ) .$$

The second device may determine an updated second encrypted distance between the third encrypted vector and the fourth encrypted vector based on the updated sub-distance corresponding to each fourth encrypted component. Optionally, the sum of the updated sub-distances corresponding to each fourth encrypted component can be determined as the updated second encrypted distance between the third encrypted vector and the fourth encrypted vector:

$${\sum }_{i = 1}^{m} ( {E}_{pka 2} ( {x}_{i}^{2} - 2 {x}_{i} {y}_{i} + {y}_{i}^{2} ) ) .$$

Similar to the above embodiment, after determining the updated second encrypted distance, the second device may decrypt the updated second encrypted distance based on the second target private key to determine the target distance between the first vector and the second vector. For example, the second device can decrypt the second encrypted distance according to the second target private key to obtain

$${\sum }_{i = 1}^{m} ( {x}_{i}^{2} - 2 {x}_{i} {y}_{i} + {y}_{i}^{2} ) ,$$

and can calculate the target distance between the first vector and the second vector based on the decrypted second encrypted distance and the Euclidean distance formula. For example, the target distance between the first vector and the second vector is

$$d = \sqrt{{\sum }_{i = 1}^{m} ( {x}_{i}^{2} - 2 {x}_{i} {y}_{i} + {y}_{i}^{2} )} ,$$

xᵢ is the i-th component in the first vector, yᵢ is the i-th component in the second vector components, m is the number of components contained in the first vector or the second vector, and the number of components contained in the first vector is the same as the number of components contained in the second component, that is, the length of the first vector is equal to the length of the second vector, the lengths of the first vector and the second vector can both be a preset length m, and m can be any positive integer.

Since the length of the first vector corresponding to the first data is equal to the length of the second vector corresponding to the second data, even if the first data and the second data are different, fuzzy matching can be achieved, which broadens the usage scenarios.

After the second device determines the target distance between the first vector and the second vector, it may also determine whether the first data matches the second data based on the target distance and the first preset distance threshold. The process of the second device determining whether the first data matches the second data may be the same as the process of the first device determining whether the first data matches the second data in the above embodiment, and will not be described again here.

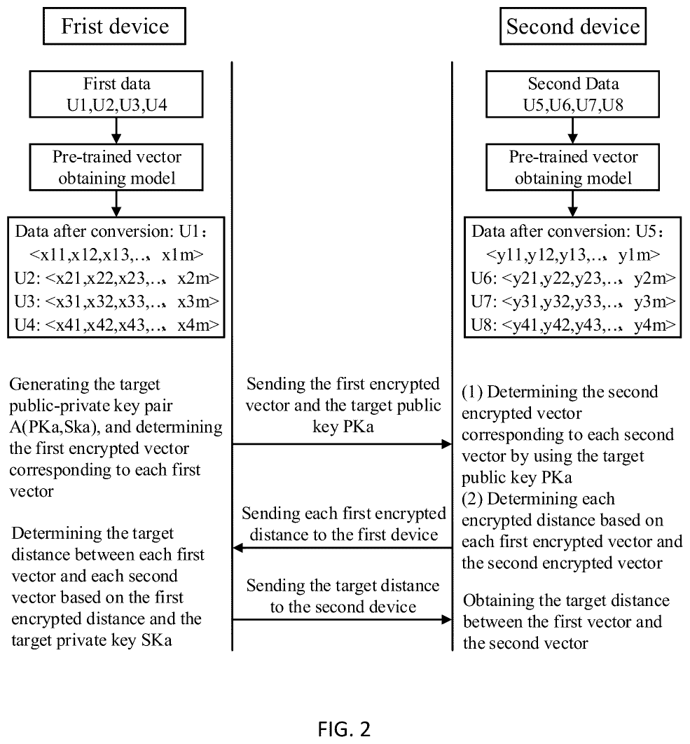

To facilitate understanding, the data matching process provided by the present disclosure is described below through a specific embodiment. FIG. 2 is a schematic diagram of the second data matching process provided by the embodiment of the present disclosure. As shown in FIG. 2, the process includes the following operations.

The first device inputs each first data to be matched into a pre-trained vector conversion model deployed in the first device, and for each first data, obtains a first vector corresponding to the first data. Similarly, the second device inputs each second data to be matched into the pre-trained vector conversion model deployed in the second device, and for each second data, obtains the second vector corresponding to the second data. As shown in FIG. 2, there are 4 first data, respectively, U1, U2, U3, and U4, and the first vector corresponding to U1 is (x11, x12, x13 . . . , x1m), and the first vector corresponding to U2 is (x21, x22, x23 . . . , x2m), the first vector corresponding to U3 is (x31, x32, x33 . . . , x3m), and the first vector corresponding to U4 is (x41, x42, x43 . . . , x4m). In addition, there are 4 second data respectively, namely U5, U6, U7, and U8, and the second vector corresponding to U5 is (y11, y12, y13 . . . , y1m), and the second vector corresponding to U6 is (y21, y22, y23 . . . , y2m), the second vector corresponding to U7 is (y31, y32, y33 . . . , y3m), and the second vector corresponding to U8 is (y41, y42, y43 . . . , y4m).

The first device generates a first target public-private key pair A(pka, ska), pka is the first target public key, ska is the first target private key, and the first target public-private key pair is a semi-homomorphic encryption target public-private key pair. For each first vector, semi-homomorphic encryption is performed on the first vector based on the first target public key pair to generate a corresponding first encrypted vector. For example, the first encrypted vector corresponding to the first vector (x11, x12, x13 . . . , x1m) is (Eₚₖₐ(x11), Eₚₖₐ(x12), Eₚₖₐ(x13) . . . , Eₚₖₐ(x1m)). The first encrypted vector corresponding to the first vector (x21, x22, x23 . . . , x2m) is (Eₚₖₐ(x21), Eₚₖₐ(x22), Eₚₖₐ(x23) . . . , Eₚₖₐ(x2m)). The first encrypted vector corresponding to the first vector (x31, x32, x33 . . . , x3m) is (Eₚₖₐ(x31), Eₚₖₐ(x32), Eₚₖₐ(x33) . . . , Eₚₖₐ(x3m)). The first encrypted vector corresponding to the first vector (x41, x42, x43 . . . , x4m) is (Eₚₖₐ(x41), Eₚₖₐ(x42), Eₚₖₐ(x43) . . . , Eₚₖₐ(x4m)).

The first device sends the first target public key and each first encrypted vector to the second device. After receiving the first target public key and each first encrypted vector, the second device perform semi-homomorphic encryption on each second vector based on the first target public key to generate a second encrypted vector. The second encrypted vector corresponding to the second vector (y11, y12, y13 . . . , y1m) is (Eₚₖₐ(y11), Eₚₖₐ(y12), Eₚₖₐ(y13) . . . , Eₚₖₐ(y1m)). The second encrypted vector corresponding to the second vector (y21, y22, y23 . . . , y2m) is (Eₚₖₐ(y21), Eₚₖₐ(y22), Eₚₖₐ(y23) . . . , Eₚₖₐ(y2m)). The second encrypted vector corresponding to the second vector (y31, y32, y33 . . . , y3m) is (Eₚₖₐ(y31), Eₚₖₐ(y32), Eₚₖₐ(y33) . . . , Eₚₖₐ(y3m)). The second encrypted vector corresponding to the second vector (y41, y42, y43 . . . , y4m) is (Eₚₖₐ(y41), Eₚₖₐ(y42), Eₚₖₐ(y43) . . . , Eₚₖₐ(y4m)).

Because for each first data, it is necessary to determine whether the first data matches each second data. For example, for the first data U1, it is necessary to determine whether the first data U1 and the second data U5 match, and whether the first data U1 and the second data U5 match, whether the first data U1 and the second data U6 matches, whether the first data U1 and the second data U7 match, whether the first data U1 and the second data U8 match. Therefore, for each first vector, the target distance between each first vector and each second vector can be determined; for each first encrypted vector, the corresponding first encrypted distance can also be calculated based on the first encrypted vector and each second encrypted vector. The process of calculating the first encrypted distance based on any first encrypted vector and any second encrypted vector is the same as the process of calculating the first encrypted distance in the above embodiment. For example, for any first encrypted vector and any second encrypted vector, the second device may send the encrypted sub-distance b=Eₚₖₐ₁(−2Eₚₖₐ₁(xᵢ)^{y}^{ᵢ}+yᵢ²) calculated based on the first encrypted vector and the second encrypted vector to the first device. The first device can update the encrypted sub-distance to Eₚₖₐ₁(xᵢ²)−2Eₚₖₐ₁(xᵢyᵢ)+Eₚₖₐ₁(yᵢ²), and use the first target private key to decrypt the updated first encrypted distance to obtain the corresponding target distance between the first vector and the second vector, which will not be described again here.

For each first vector, after determining the target distance between each first vector and each second vector, the first device can also send the determined target distance to the second device. Both the first device and the second device can determine whether the first data corresponding to the first vector matches the second data corresponding to each second vector based on the target distance and the first preset distance threshold, that is, whether each first data and each second data match, can be determined respectively.

To facilitate understanding, the data matching process provided by the present disclosure will be described below through a specific embodiment. Assume that there are three pieces of first data stored in the first device, which are “Qing canteen, Dongxin District, Sea City”, “Tian restaurant, Sea city”, and “Yang Malatang, Gao Road”. There are also three pieces of second data stored in the second device, namely “Qing canteen, Dongxin District, Sea City”, “Tian restaurant, Sea city”, and “Maimoulao”.

In the first data, the first vector corresponding to “Qing canteen, Dongxin District, Sea City” is <1.0, 2.0, 1.5, 2.0, 3.5>, recorded as A1. The first vector corresponding to “Tian restaurant, Sea city” is <3.0, 4.0, 2.5, 2.5, 1.5>, recorded as A2. The first vector corresponding to “Yang Malatang, Gao Road” is <4.5, 5.5, 7.5, 1.5, 0.5>, recorded as A3.

In the second data, the second vector corresponding to “Qing canteen, Dongxin District, Sea City” is <1.0, 2.0, 1.5, 1.0, 3.5>, recorded as B1. The second vector corresponding to “Tian restaurant, Sea city” is <3.0, 4.0, 2.5, 2.5, 1.5>, recorded as B2. The second vector corresponding to “Maimoulao” is <3.5, 6.5, 2.5, 7.5, 2.5>, recorded as B3.

The first device generates a first target public-private key pair A(pka, ska), pka is the first target public key, ska is the first target private key, and the first target public-private key pair is a semi-homomorphic encryption target public-private key pair. For each first vector, the first device may perform semi-homomorphic encryption on the first vector based on the first target public key pair to generate a corresponding first encrypted vector.

The first device sends the first target public key and each first encrypted vector to the second device. After receiving the first target public key and each first encrypted vector, the second device perform semi-homomorphic encryption on the second vector based on the first target public key to generate a second encrypted vector.

Since for each first data, it is necessary to determine whether the each first data matches each second data, therefore, for each first vector, the target distance between the each first vector and each second vector can be determined, for each first encrypted vector, a corresponding first encrypted distance may also be calculated based on the each first encrypted vector and each second encrypted vector. The process of calculating the first encrypted distance based on any first encrypted vector and any second encrypted vector is the same as the process of calculating the first encrypted distance in the above embodiment, and will not be described again here.

As shown in Table 1, Table 1 is a schematic table of target distances provided by some embodiments of the present disclosure.

TABLE 1

| D(x, y) | B1 | B2 | B3 |
|---|---|---|---|
| A1 | 1 | 3.64 | 7.66 |
| A2 | 3.9 | 0 | 5.7 |
| A3 | 8.35 | 5.61 | 8.18 |

Assume that D(x, y) represents the target distance, x represents the first vector and y represents the second vector. The target distance corresponding to A1 and B1 is 1, the target distance corresponding to A1 and B2 is 3.64, the target distance corresponding to A1 and B3 is 7.66, the target distance corresponding to A2 and B1 is 3.9, the target distance corresponding to A2 and B2 is 0, the target distance corresponding to A2 and B3 is 5.7, the target distance corresponding to A3 and B1 is 8.35, the target distance corresponding to A3 and B2 is 5.16, and the target distance corresponding to A3 and B3 is 8.18.

Assuming that the first distance threshold is 2, the fuzzy matching result of this time is that “Qing canteen, Dongxin District, Sea City” in the first data matches “Qing canteen, Dongxin District, Sea City” in the second data. The “Tian restaurant, Sea city” in the first data matches “Tian restaurant, Sea city” in the second data. From this, it can also be seen that the fuzzy matching of data can also be achieved by the data matching method in the present disclosure when two data are completely different, thereby broadening the application scenarios.

To facilitate understanding, the data matching process provided by the present disclosure will be described below through a specific embodiment. It is assumed that there are three pieces of first data stored in the first device, namely three mobile phone numbers “13345678909”, “13245678911”, and “13334536787”. There are also three pieces of second data stored in the second device, which are three mobile phone numbers “13334536787”, “13345678908”, and “15439402290”.

The first device and the second device can vectorize the mobile phone numbers in the first data and the second data respectively using the One-Hot encoding model (data conversion model) to generate corresponding first vectors and second vectors. Optionally, the vector dimensions of the first vectors and the second vectors may be 10*11 dimensions, 10 represents a total of 10 numbers from 0 to 9, and 11 represents a mobile phone number with a length of 11 digits. For example, refer to Table 2, which is a vector representation corresponding to the mobile phone number “13345678909”.

TABLE 2

| One number of the mobile phone | Vector corresponding to the number |
|---|---|
| number | (One-hot code) |
| 1 | 0000000010 |
| 3 | 0000001000 |
| 3 | 0000001000 |
| 4 | 0000010000 |
| 5 | 0000100000 |
| 6 | 0001000000 |
| 7 | 0010000000 |
| 8 | 0100000000 |
| 9 | 1000000000 |
| 0 | 0000000001 |
| 9 | 1000000000 |

Referring to Table 2, in a possible implementation, the one-hot code corresponding to 0 is 0000000001, the one-hot code corresponding to 1 is 0000000010, the one-hot code corresponding to 2 is 0000000100, the one-hot code corresponding to 3 is 0000001000, the one-hot code corresponding to 4 is 0000010000, the one-hot code corresponding to 5 is 0000100000, the one-hot code corresponding to 6 is 0001000000, the one-hot code corresponding to 7 is 0010000000, the one-hot code corresponding to 8 is 0100000000, and the one-hot code corresponding to 9 is 1000000000. Then the first vector (or second vector) corresponding to the mobile phone number “13345678909” can be (0000000010, 0000001000, 0000001000, 0000010000, 0000100000, 0001000000, 0010000000, 0100000000, 10000 00000, 0000000001, 1000000000). The process of determining the vectors corresponding to other mobile phone numbers is similar to this process and will not be described again here.

For convenience of description, the first vector corresponding to “13345678909” in the first data is marked as A4, the first vector corresponding to “13245678911” is marked as A5, and the first vector corresponding to “13334536787” is marked as A6. The second vector corresponding to “13334536787” in the second data is recorded as B4, the second vector corresponding to “13345678908” is recorded as B5, and the second vector corresponding to “15439402290” is recorded as B6.

The first device generates a first target public-private key pair A(pka, ska), pka is the first target public key, ska is the first target private key, and the first target public-private key pair is a semi-homomorphic encryption target public-private key pair. For each first vector, the first device may perform semi-homomorphic encryption on the first vector based on the first target public key pair to generate a corresponding first encrypted vector.

The first device sends the first target public key and each first encrypted vector to the second device. After receiving the first target public key and each first encrypted vector, the second device performs semi-homomorphic encryption on the second vector based on the first target public key to generate a second encrypted vector.

Since for each first data, it is necessary to determine whether the each first data matches each second data, therefore, for each first vector, the target distance between the each first vector and each second vector can be determined, for each first encrypted vector, a corresponding first encrypted distance may also be calculated based on the each first encrypted vector and each second encrypted vector. The process of calculating the first encrypted distance based on any first encrypted vector and any second encrypted vector is the same as the process of calculating the first encrypted distance in the above embodiment, and will not be described again here.

As shown in Table 3, Table 3 is a schematic table of target distances provided by some embodiments of the present disclosure.

TABLE 3

| D(x, y) | B4 | B5 | B6 |
|---|---|---|---|
| A4 | 2.82 | 1 | 3.16 |
| A5 | 3 | 1.73 | 3 |
| A6 | 0 | 2.82 | 3 |

Assume that D(x, y) represents the target distance, x represents the first vector and y represents the second vector. The target distance corresponding to A4 and B4 is 2.82, the target distance corresponding to A4 and B5 is 1, the target distance corresponding to A4 and B6 is 3.16, the target distance corresponding to A5 and B4 is 3, the target distance corresponding to A5 and B5 is 1.73, the target distance corresponding to A5 and B6 is 3, the target distance corresponding to A6 and B4 is 0, the target distance corresponding to A6 and B5 is 2.83, and the target distance corresponding to A6 and B6 is 3.

Assuming that the first distance threshold is 2, the result of this fuzzy matching is that “13345678909” in the first data matches “13345678909” in the second data, and “13334536787” in the first data matches “13334536787” in the second data. It can also be seen that the data matching method in the present disclosure can not only achieve fuzzy matching of data, but also achieve precise matching of data, thereby broadening the application scenarios.

### Example 5

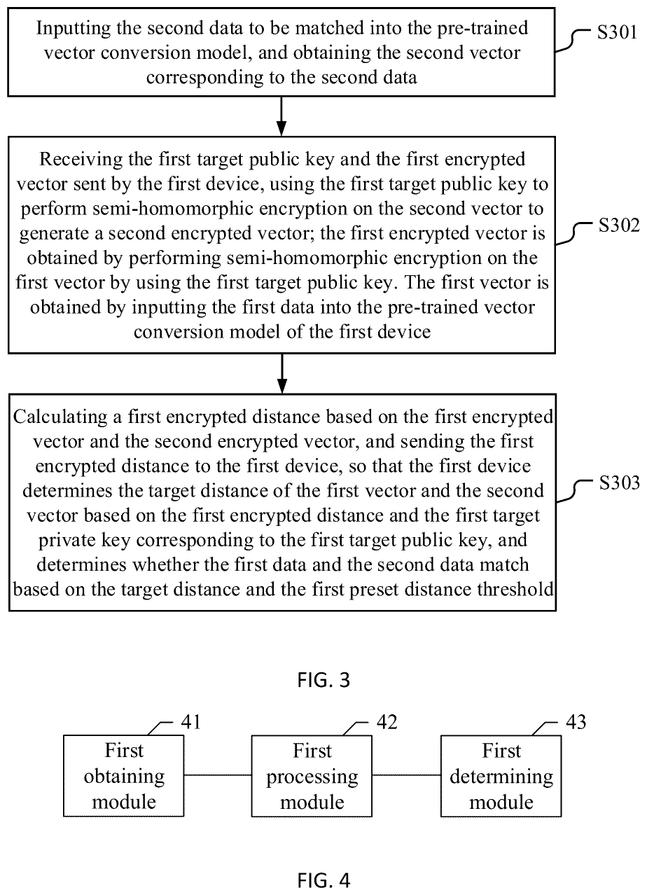

Based on the same technical concept, the present disclosure provides a data matching method, applied to the second device. FIG. 3 is a schematic diagram of the third data matching process provided by the embodiment of the present disclosure. As shown in FIG. 3, the method includes:

S301: inputting the second data to be matched into the pre-trained vector conversion model, and obtaining the second vector corresponding to the second data.

The data matching method provided by the embodiment of the present disclosure is applied to a second device. The second device may be a smart terminal, a PC, a server, and other devices, and the second device is a different device from the first device in the present disclosure.

S302: receiving the first target public key and the first encrypted vector sent by the first device, using the first target public key to perform semi-homomorphic encryption on the second vector to generate a second encrypted vector; the first encrypted vector is obtained by performing semi-homomorphic encryption on the first vector by using the first target public key. The first vector is obtained by inputting the first data into the pre-trained vector conversion model of the first device.

S303: calculating a first encrypted distance based on the first encrypted vector and the second encrypted vector, and sending the first encrypted distance to the first device, so that the first device determines the target distance between the first vector and the second vector based on the first encrypted distance and the first target private key corresponding to the first target public key, and determines whether the first data matches the second data based on the target distance and the first preset distance threshold.

In a possible implementation, inputting the second data to be matched into a pre-trained vector conversion model, and obtaining the second vector corresponding to the second data includes:
determining the second target data type corresponding to the second data;
determining the second pre-trained target vector conversion model corresponding to the second data according to the second target data type and the corresponding relationship between the pre-stored data type and the pre-trained vector conversion model;
inputting the second data into the second pre-trained target vector conversion model to obtain the second vector corresponding to the second data.

In a possible implementation, the second target data type is at least one of a text type, a numeric type, or an image type.

In a possible implementation, if the second target data type is a text type, the second pre-trained target vector conversion model corresponding to the second target data type is a word vector model or a sentence vector model. If the second target data type is a numeric type, and the second pre-trained target vector conversion model corresponding to the second target data type is a one-hot encoding model. If the second target data type is an image type, the pre-trained second target vector conversion model corresponding to the second target data type is an image vector model.

In a possible implementation, the method further includes:
using the second target public key generated by the second device to perform semi-homomorphic encryption on the second vector to generate a third encrypted vector, and sending the second target public key and the third encrypted vector to the first device;
receiving a second encrypted distance calculated based on the third encrypted vector and a fourth encrypted vector sent by the first device, where the fourth encrypted vector is obtained by performing semi-homomorphic encryption on the first vector using the second target public key; the first vector is obtained by inputting the first data into the pre-trained vector conversion model in the first device;
determining the target distance between the first vector and the second vector based on the second encrypted distance and the second target private key corresponding to the second target public key, and causing the second device to determine whether the first data matches the second data based on the target distance and a first preset distance threshold.

In a possible implementation, after sending the first encrypted distance to the first device, the method further includes:
receiving the target distance sent by the first device, and determining whether the first data matches the second data based on the target distance and a first preset distance threshold.

In a possible implementation, the method further includes:
receiving a matching result indicating whether the first data matches the second data, sent by the first device.

In a possible implementation, using the first target public key to perform semi-homomorphic encryption on the second vector to generate a second encrypted vector, includes:
for each second component in the second vector, performing semi-homomorphic encryption on each second component in the second vector based on the first target public key to generate the second encrypted vector.

### Example 6

Based on the same technical concept, the present disclosure provides a data matching device, which is applied to the first device. FIG. 4 is a schematic diagram of a structure of a data matching device provided by some embodiments of the present disclosure. As shown in FIG. 4, the device includes:
a first obtaining module 41 configured to input the first data to be matched into a pre-trained vector conversion model, and obtain the first vector corresponding to the first data;
a first processing module 42 configured to perform semi-homomorphic encryption on the first vector using the first target public key generated by the first device to generate a first encrypted vector, and send the first target public key and the first encrypted vector to the second device;
the first obtaining module 41 is also configured to obtain the first encrypted distance calculated based on the first encrypted vector and the second encrypted vector sent by the second device, and the second encrypted vector is calculated by using the first target public key to perform semi-homomorphic encryption on the second vector; the second vector is obtained by inputting the second data into the pre-trained vector conversion model in the second device;
a first determining module 43 configured to determine the target distance between the first vector and the second vector based on the first encrypted distance and the first target private key corresponding to the first target public key, and determine whether the first data matches the second data based on the target distance and a first preset distance threshold.

In a possible implementation, the first obtaining module 41 is specifically configured to determine the first target data type corresponding to the first data;
determine the first pre-trained target vector conversion model corresponding to the first data according to the first target data type and the corresponding relationship between and the pre-stored data type and the pre-trained vector conversion model;
input the first data into the first pre-trained target vector conversion model to obtain the first vector corresponding to the first data.

In a possible implementation, the first target data type is at least one of a text type, a numeric type, or an image type.

In a possible implementation, if the first target data type is a text type, the first pre-trained target vector conversion model corresponding to the first target data type is a word vector model or a sentence vector model; if The first target data type is a numeric type, and the first pre-trained target vector conversion model corresponding to the first target data type is a one-hot encoding model; if the first target data type is an image type, the first pre-trained target vector conversion model corresponding to the first target data type is an image vector model.

In a possible implementation, the device further includes:
a receiving module configured to receive a third encrypted vector sent by the second device and a second target public key generated by the second device; the third encrypted vector is obtained by using the second target public key to perform after semi-homomorphic encryption on the second vector by the second device;
the first processing module is further configured to perform semi-homomorphic encryption on the first vector based on the second target public key to generate a fourth encrypted vector;
a sending module configured to calculate and obtain a second encrypted distance based on the third encrypted vector and the fourth encrypted vector, and send the second encrypted distance to the second device, so that the second device can calculate the target distance between the first vector and the second vector based on the second encrypted distance and the second target private key corresponding to the second target public key, and determine whether the first data matches the second data based on the target distance and a first preset distance threshold.

In a possible implementation, the first sending module is further configured to send the target distance to the second device, so that the second device can determine whether the first data matches the second data based on the target distance and the preset first distance.

In a possible implementation, the first sending module is further configured to send the determined matching result of whether the first data matches the second data to the second device.

In a possible implementation, the first processing module is specifically configured to, for each first component in the first vector, perform semi-homomorphic encryption on each first component in the first vector based on the first target public key to generate the first encrypted vector.

In a possible implementation, the lengths of the first vector and the second vector are both preset lengths.

In a possible implementation, the first encrypted distance is obtained using the following process:
for each first encrypted component in the first encrypted vector and each second encrypted component in the second encrypted vector, determining the product of the first encrypted component and the corresponding second encrypted component and the corresponding second encrypted square component of the second encrypted component through a semi-homomorphic encryption algorithm; determining the encrypted sub-distance corresponding to the first encrypted component based on the product and the second encrypted square component;
determining a first encrypted distance between the first encrypted vector and the second encrypted vector based on the encrypted sub-distance corresponding to each first encrypted component.

In a possible implementation, the first determining module 43 is specifically configured to determine, for each first encrypted component in the first encrypted vector, the first encrypted square component of the first encrypted component, and update the encrypted sub-distance corresponding to the first encrypted component based on the first encrypted square component and the encrypted sub-distance corresponding to the first encrypted component;
determine the updated first encrypted distance between the first encrypted vector and the second encrypted vector based on the updated sub-distance corresponding to each first encrypted component;
decrypt the updated first encrypted distance to obtain the target distance between the first vector and the second vector by using the first target private key corresponding to the first target public key.

In a possible implementation, the first encrypted distance is obtained using the following process:
for each first encrypted component in the first encrypted vector and each second encrypted component in the second encrypted vector, determining a first encrypted square component of the first encrypted component, the product of the first encrypted component and the corresponding second encrypted component, and the second encrypted square component of the corresponding second encrypted component through a semi-homomorphic encryption algorithm; determining the encrypted sub-distance corresponding to the first encrypted component based on the first encrypted square component, the product and the second encrypted square component;
determining a first encrypted distance between the first encrypted vector and the second encrypted vector based on the encrypted sub-distance corresponding to each first encrypted component.

In a possible implementation, the first determining module 43 is specifically configured to determine the product of the first encrypted component number of exponential powers, the exponent of the exponential power is the corresponding second encrypted component;
determine the sum of the first encrypted component number of corresponding second encrypted components based on the product of the first encrypted component number of exponential powers;
determine a product of the first encrypted component and the corresponding second encrypted component based on the sum of the first encrypted component number of the corresponding second encrypted components.

In a possible implementation, the first determining module 43 is specifically configured to determine whether the target distance is less than a first preset distance threshold;

If yes, it is determined that the first data matches the second data;

Otherwise, it is determined that the first data and the second data do not match.

In a possible implementation, the first determining module 43 is also configured to determine whether the target distance is equal to a second preset distance threshold, and if so, determine the first data are the same as the second data.

### Example 7

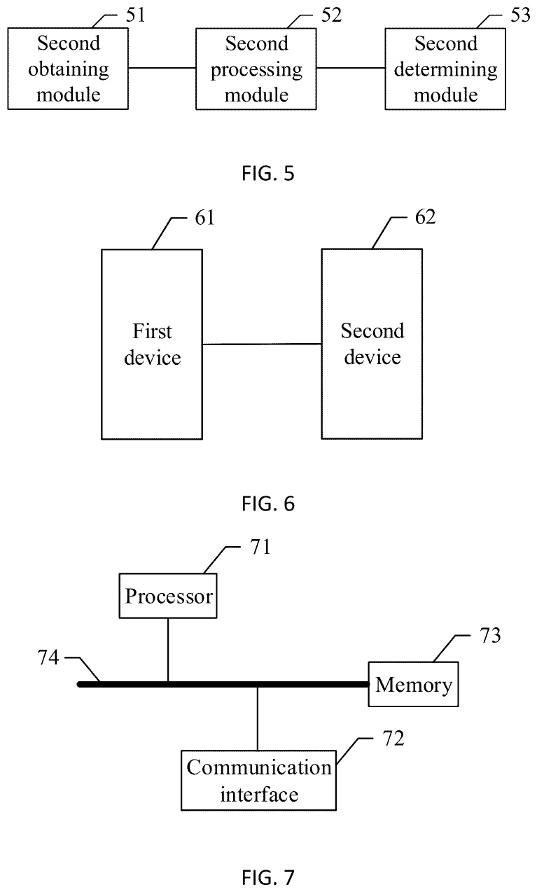

Based on the same technical concept, the present disclosure provides another data matching device, which is applied to the second device. FIG. 5 is a schematic diagram of a structure of another data matching device provided by some embodiments of the present disclosure. As shown in FIG. 5, the device includes:
a second obtaining module 51 configured to input the second data to be matched into the pre-trained vector conversion model, and obtain the second vector corresponding to the second data;
a second processing module 52 configured to receive the first target public key and the first encrypted vector sent by the first device, and use the first target public key to perform semi-homomorphic encryption on the second vector to generate a second encrypted vector; the first encrypted vector is obtained by performing semi-homomorphic encryption on the first vector using the first target public key, and the first vector is obtained by inputting the first data in to a pre-trained vector conversion model in the first device;
a second determining module 53 configured to calculate a first encrypted distance based on the first encrypted vector and the second encrypted vector, and send the first encrypted distance to the first device, so that the first device can calculate the target distance between the first vector and the second vector based on the first encrypted distance and the first target private key corresponding to the first target public key; and cause the first device to determine whether the first data matches the second data based on the target distance and the first preset distance threshold.

In a possible implementation, the second obtaining module 51 is specifically configured to determine the second target data type corresponding to the second data;
determine the second pre-trained target vector conversion model corresponding to the second data according to the second target data type and the corresponding relationship between and the pre-stored data type and the pre-trained vector conversion model;
input the second data into the second pre-trained target vector conversion model to obtain the second vector corresponding to the second data.

In a possible implementation, the second target data type is at least one of a text type, a numeric type, or an image type.

In a possible implementation, if the second target data type is a text type, the second pre-trained target vector conversion model corresponding to the second target data type is a word vector model or a sentence vector model; if The second target data type is a numeric type, and the second pre-trained target vector conversion model corresponding to the second target data type is a one-hot encoding model; if the second target data type is an image type, the first pre-trained target vector conversion model corresponding to the second target data type is an image vector model.

In a possible implementation, the second processing module 52 is also configured to use the second target public key generated by the second device to perform semi-homomorphic encryption on the second vector to generate a third encrypted vector, and send the second target public key and the third encrypted vector to the first device; receive the second encrypted distance calculated based on the third encrypted vector and the fourth encrypted vector sent by the first device; the fourth encrypted vector is obtained by using the second target public key to perform semi-homomorphic encryption on the first vector; the first vector is obtained by inputting the first data into the pre-training vector conversion model in the first device; determine the target distance between the first vector and the second vector based on the second encrypted distance and the second target private key corresponding to the second target public key, and enable the second device to determine whether the first data matches the second data based on the target distance and a first preset distance threshold.

In a possible implementation, the second determining module 53 is also configured to receive the target distance sent by the first device, and determine whether the first data matches the second data the first distance based on the target distance and the first preset distance threshold.

In a possible implementation, the second determining module 53 is also configured to receive a matching result of whether the first data matches the second data, sent by the first device.

In a possible implementation, the second obtaining module 51 is further configured to, for each second component in the second vector, perform semi-homomorphic encryption on each second component in the second vector based on the first target public key to generate the second encrypted vector.

### Example 8

Based on the same technical concept, the present disclosure provides a data matching system. FIG. 6 is a schematic diagram of a structure of a data matching system provided by some embodiments of the present disclosure. As shown in FIG. 6, the system includes:
a first device 61 configured to input the first data to be matched into the pre-trained vector conversion model to obtain the first vector corresponding to the first data; and use the first target public key generated by itself to perform semi-homomorphic encryption on the first vector to generate a first encrypted vector, and send the first target public key and the first encrypted vector to a second device 62;
the second device 62 configured to input the second data to be matched into the pre-trained vector conversion model, obtain the second vector corresponding to the second data; and receive the first target public key and the first encrypted vector sent by the first device, use the first target public key to perform semi-homomorphic encryption on the second vector to generate a second encrypted vector; calculate the first encryption distance based on the first encrypted vector and the second encrypted vector, send the first encrypted distance to the first device 61.

The first device 61 is further configured to determine the target distance between the first vector and the second vector based on the first encrypted distance and the first target private key corresponding to the first target public key, and determine whether the first data matches the second data based on the target distance and the first preset distance threshold.

Based on the same technical concept, the present disclosure also provides an electronic device. FIG. 7 is a schematic diagram of a structure of an electronic device provided by some embodiments of the present disclosure. As shown in FIG. 7, it includes: a processor 71, a communication interface 72, and a memory 73 and communication bus 74. The processor 71, communication interface 72, and memory 73 complete communication with each other through the communication bus 74.

The memory 73 stores a computer program. When the program is executed by the processor 71, the processor 71 is configured to perform the steps of the data matching method of any of the above embodiments.

Since the problem-solving principle of the above-mentioned electronic device is similar to the data matching method, the implementation of the above-mentioned electronic device can be referred to the implementation of the method, and repeated details will not be repeated.

The communication bus mentioned in the above electronic device may be a Peripheral Component Interconnect (PCI) bus or an Extended Industry Standard Architecture (EISA) bus, etc. The communication bus can be divided into address bus, data bus, control bus, etc. For ease of presentation, only one thick line is used in the figure, but it does not mean that there is only one bus or one type of bus.

The communication interface 72 is used for communication between the above-mentioned electronic device and other devices.

The memory may include random access memory (Random Access Memory, RAM) or non-volatile memory (Non-Volatile Memory, NVM), such as at least one disk memory. Optionally, the memory may also be at least one storage device located remotely from the aforementioned processor.

The above-mentioned processor can be a general-purpose processor, including a central processing unit, a network processor (Network Processor, NP), etc.; it can also be a digital signal processor (Digital Signal Processing, DSP), an application-specific integrated circuit, a field programmable gate array, or other programmable logic devices, discrete gate or transistor logic devices, discrete hardware components, etc.

Based on the same technical concept, embodiments of the present disclosure provide a computer-readable storage medium. The computer-readable storage medium stores a computer program that can be executed by an electronic device. When the program is run on the electronic device, the electronic device implements the steps of the data matching method of any of the above embodiments when executed. Since the problem-solving principle of the above computer-readable storage medium is similar to the data matching method, the implementation of the above-mentioned computer-readable storage medium can be referred to the implementation of the method, and repeated details will not be repeated.

The above-mentioned computer-readable storage media can be any available media or data storage devices that can be accessed by the processor in the electronic device, including but not limited to magnetic memories such as floppy disks, hard disks, magnetic tapes, magneto-optical disks (MO), etc., and optical memories such as CD, DVD, BD, HVD, etc., as well as semiconductor memories such as ROM, EPROM, EEPROM, non-volatile memory (NAND FLASH), solid state drive (SSD), etc.

Based on the same technical concept and on the basis of the above embodiments, the present disclosure provides a computer program product. The computer program product includes: computer program code. When the computer program code is run on a computer, the computer performs the steps of the data matching method as described in any one of the above.

Those skilled in the art will understand that embodiments of the present disclosure may be provided as methods, systems, or computer program products. Accordingly, the present disclosure may take the form of an entirely hardware embodiment, an entirely software embodiment, or an embodiment that combines software and hardware aspects. Furthermore, the present disclosure may take the form of a computer program product embodied on one or more computer-usable storage media (including, but not limited to, disk storage, CD-ROM, optical storage, etc.) having computer-usable program code embodied therein.

The present disclosure is described with reference to flowchart illustrations and/or block diagrams of methods, apparatus (systems), and computer program products according to the present disclosure. It will be understood that each process and/or block in the flowchart illustrations and/or block diagrams, and combinations of processes and/or blocks in the flowchart illustrations and/or block diagrams, can be implemented by computer program instructions. These computer program instructions may be provided to a processor of a general purpose computer, special purpose computer, embedded processor, or other programmable data processing device to produce a machine, such that the instructions executed by the processor of the computer or other programmable data processing device produce a device for realizing the functions specified in one process or multiple processes of the flowchart and/or one block or multiple blocks of the block diagram.

These computer program instructions may also be stored in a computer-readable memory that causes a computer or other programmable data processing apparatus to operate in a particular manner, such that the instructions stored in the computer-readable memory produce an article of manufacture including the instruction means, the instructions The device implements the functions specified in a process or processes of the flowchart and/or a block or blocks of the block diagram.

These computer program instructions may also be loaded onto a computer or other programmable data processing device, causing a series of operating steps to be performed on the computer or other programmable device to produce computer-implemented processing, thereby executing on the computer or other programmable device. Instructions provide steps for implementing the functions specified in a process or processes of a flowchart diagram and/or a block or blocks of a block diagram.

Obviously, those skilled in the art can make various changes and modifications to the present disclosure without departing from the spirit and scope of the present disclosure. In this way, if these modifications and variations of the present disclosure fall within the scope of the claims of the present disclosure and equivalent technologies, the present disclosure is also intended to include these modifications and variations.

1. A data matching method, applied to a first device, wherein the data matching method comprises:
inputting first data to be matched into a pre-trained vector conversion model, and obtaining a first vector corresponding to the first data;
using a first target public key generated by the first device to perform semi-homomorphic encryption on the first vector to generate a first encrypted vector, and sending the first target public key and the first encrypted vector to a second device;
obtaining a first encrypted distance sent by the second device, wherein the first encrypted distance is calculated based on the first encrypted vector and a second encrypted vector, the second encrypted vector is obtained by performing the semi-homomorphic encryption on a second vector by using the first target public key, and the second vector is obtained by inputting second data into a pre-trained vector conversion model in the second device;
determining a target distance between the first vector and the second vector based on the first encrypted distance and a first target private key corresponding to the first target public key; and
determining whether the first data matches the second data based on the target distance and a first preset distance threshold.

2. The data matching method according to claim 1, wherein the inputting the first data to be matched into the pre-trained vector conversion model, and obtaining the first vector corresponding to the first data, comprises:
determining a first target data type corresponding to the first data;
determining a first pre-trained target vector conversion model corresponding to the first data according to the first target data type and a corresponding relationship between pre-stored data types and pre-trained vector conversion models; and
inputting the first data into the first pre-trained target vector conversion model to obtain the first vector corresponding to the first data.

3. The data matching method according to claim 2, wherein the first target data type is at least one of a text type, a numeric type, or an image type;
wherein based on the first target data type being the text type, the first pre-trained target vector conversion model corresponding to the first target data type is a word vector model or a sentence vector model;
based on the first target data type being the numeric type, the first pre-trained target vector conversion model corresponding to the first target data type is a one-hot encoding model: based on the first target data type being the image type, the first pre-trained target vector conversion model corresponding to the first target data type is an image vector model.

4. (canceled)

5. The data matching method according to claim 1, further comprising:
receiving a third encrypted vector sent by the second device and a second target public key generated by the second device; wherein the third encrypted vector is generated by the second device using the second target public key to perform the semi-homomorphic encryption on the second vector;
performing the semi-homomorphic encryption on the first vector based on the second target public key to generate a fourth encrypted vector; and
calculating and obtaining a second encrypted distance based on the third encrypted vector and the fourth encrypted vector, and sending the second encrypted distance to the second device, to cause the second device to determine the target distance between the first vector and the second vector based on the second encrypted distance and a second target private key corresponding to the second target public key, and to cause the second device to determine whether the first data matches the second data based on the target distance and the first preset distance threshold.

6. The data matching method according to claim 1, after determining the target distance between the first vector and the second vector, the method further comprises:
sending the target distance to the second device, to cause the second device to determine whether the first data matches the second data based on the target distance and the first preset distance threshold.

7. The data matching method according to claim 1, further comprising:
sending a determined matching result of whether the first data matches the second data to the second device.

8. The data matching method according to claim 1, wherein the using the first target public key generated by the first device, to perform the semi-homomorphic encryption on the first vector to generate the first encrypted vector, comprises:
for each first component in the first vector, performing the semi-homomorphic encryption on the each first component in the first vector based on the first target public key to generate the first encrypted vector.

9. The data matching method according to claim 1, wherein lengths of the first vector and the second vector are both preset lengths.

10. The data matching method according to claim 8, wherein the first encrypted distance is obtained using a following process:
for each first encrypted component in the first encrypted vector, each second component in the second vector, and each second encrypted component in the second encrypted vector, determining, through a semi-homomorphic encryption algorithm, a product of the first encrypted component and a corresponding second encrypted component and a second encrypted square component of the corresponding second encrypted component; and determining an encrypted sub-distance corresponding to the first encrypted component based on the product and the second encrypted square component; and
determining the first encrypted distance between the first encrypted vector and the second encrypted vector based on the encrypted sub-distance corresponding to the each first encrypted component,
or
the first encrypted distance is obtained using a following process:
for each first encrypted component in the first encrypted vector, each second component in the second vector, and each second encrypted component in the second encrypted vector, determining, through a semi-homomorphic encryption algorithm, a first encrypted square component of the first encrypted component, a product of the first encrypted component and a corresponding second encrypted component and a second encrypted square component of the corresponding second encrypted component; and determining an encrypted sub-distance corresponding to the first encrypted component based on the first encrypted square component, the product and the second encrypted square component; and
determining the first encrypted distance between the first encrypted vector and the second encrypted vector based on the encrypted sub-distance corresponding to the each first encrypted component.

11. The data matching method according to claim 10, wherein the determining the target distance between the first vector and the second vector based on the first encrypted distance and the first target private key corresponding to the first target public key, comprises:
for each first encrypted component in the first encrypted vector, determining a first encrypted square component of the each first encrypted component; updating the encrypted sub-distance corresponding to the each first encrypted component based on the first encrypted square component and the encrypted sub-distance corresponding to the each first encrypted component;
determining updated first encrypted distance between the first encrypted vector and the second encrypted vector based on updated sub-distance corresponding to each first encrypted component; and
using the first target private key corresponding to the first target public key to decrypt the updated first encrypted distance to obtain the target distance between the first vector and the second vector.

12. (canceled)

13. The data matching method according to claim 10, wherein the determining, through the semi-homomorphic encryption algorithm, the product of the first encrypted component and the corresponding second encrypted component, comprises:
determining an encrypted exponential power through the semi-homomorphic encryption algorithm, wherein a base of the exponential power is the first encrypted component, and an exponent of the exponential power is a corresponding second component; and the exponential power is used for determining the product of the first encrypted component and the corresponding second encrypted component which are encrypted by the semi-homomorphic encryption algorithm.

14. The data matching method according to claim 1, wherein the determining whether the first data matches the second data based on the target distance and the first preset distance threshold, comprises:
determining whether the target distance is less than the first preset distance threshold;
determining that the first data matches the second data based on the target distance being less than the first preset distance threshold; and
determining that the first data does not match the second data based on the target distance not being less than a first preset distance threshold.

15. The data matching method according to claim 14, wherein after determining that the first data matches the second data, the method further comprises:
determining whether the target distance is equal to a second preset distance threshold, and determining that the first data is the same as the second data based on the target distance being equal to the second preset distance threshold.

16. A data matching method, applied to a second device, wherein the method comprises:
inputting second data to be matched into a pre-trained vector conversion model, and obtaining a second vector corresponding to the second data;
receiving a first target public key and a first encrypted vector sent by the first device, and using the first target public key to perform semi-homomorphic encryption on the second vector to generate a second encrypted vector; wherein the first encrypted vector is obtained by performing the semi-homomorphic encryption on a first vector by using the first target public key, and the first vector is obtained by inputting first data into a pre-trained vector conversion model in the first device; and
calculating a first encrypted distance based on the first encrypted vector and the second encrypted vector, and sending the first encrypted distance to the first device, to cause the first device to determine a target distance between the first vector and the second vector based on the first encrypted distance and a first target private key corresponding to the first target public key, and to cause the first device to determine whether the first data matches the second data based on the target distance and a first preset distance threshold.

17. The data matching method according to claim 16, wherein the inputting the second data to be matched into the pre-trained vector conversion model, and obtaining the second vector corresponding to the second data, comprises:
determining a second target data type corresponding to the second data;
determining a second pre-trained target vector conversion model corresponding to the second data according to the second target data type and a corresponding relationship between pre-stored data types and pre-trained vector conversion models; and
inputting the second data into the second pre-trained target vector conversion model to obtain the second vector corresponding to the second data.

18. The data matching method according to claim 17, wherein the second target data type is at least one of a text type, a numeric type, or an image type,
wherein based on the second target data type being the text type, the second pre-trained target vector conversion model corresponding to the second target data type is a word vector model or a sentence vector model;
based on the second target data type being the numeric type, the second pre-trained target vector conversion model corresponding to the second target data type is a one-hot encoding model;
based on the second target data type being the image type, the second pre-trained target vector conversion model corresponding to the second target data type is an image vector model.

19. (canceled)

20. The data matching method according to claim 16, further comprising:
using a second target public key generated by the second device to perform the semi-homomorphic encryption on the second vector to generate a third encrypted vector, and sending the second target public key and the third encrypted vector to the first device;
receiving a second encrypted distance sent by the first device, wherein the second encrypted distance is calculated based on the third encrypted vector and a fourth encrypted vector, the fourth encrypted vector is obtained by using the second target public key to perform the semi-homomorphic encryption on the first vector, and the first vector is obtained by inputting the first data into the pre-trained vector conversion model in the first device; and
determining the target distance between the first vector and the second vector based on the second encrypted distance and a second target private key corresponding to the second target public key, and causing the second device to determine whether the first data matches the second data based on the target distance and the first preset distance threshold.

21. The data matching method according to claim 16, wherein after sending the first encrypted distance to the first device, the method further comprises:
receiving the target distance sent by the first device, and determining whether the first data matches the second data based on the target distance and the first preset distance threshold.

22. The data matching method according to claim 16, further comprising:
receiving a matching result of whether the first data matches the second data sent by the first device.

23. The data matching method according to claim 16, the using the first target public key to perform the semi-homomorphic encryption on the second vector to generate the second encrypted vector, comprises:
for each second component in the second vector, performing the semi-homomorphic encryption on the each second component in the second vector based on the first target public key to generate the second encrypted vector.

24. (canceled)

25. (canceled)

26. (canceled)

27. (canceled)

28. (canceled)
